(19) United States
(12) Patent Application Publication
(10) Pub. No.: US 2009/0124268 A1
(43) Pub. Date: May 14, 2009

(54) Systems and Methods for Advertising Through Text Messaging

(75) Inventors: Justin McNamara, Atlanta, GA (US); Jeffrey Mikan, Atlanta, GA (US); John Lewis, Lawrenceville, GA (US); Fulvio Arturo Cenciarelli, Suwanee, GA (US)

Correspondence Address: AT&T Legal Department - Moazzam;Attn: Patent Docketing, Room 2A-207, One AT&T Way, Bedminster, NJ, 07921, US

(73) Assignee: AT&T MOBILITY II LLC, Atlanta, GA (US)

(21) Appl. No.: 11/937,330

(22) Filed: Nov. 8, 2007

(51) Int. Cl. H04Q 7/20

(52) U.S. Cl. 455/466

(57) ABSTRACT

Systems and methods are disclosed which relate to text messaging and advertising. Fonts and Emoticon sets are designed by advertisers to resemble a product, service, trademark, etc. These fonts and emoticon sets are then used in text messages by any and all text message users. The advertisers offer to pay a subsidiary amount for the text message as an incentive for users to use their fonts and emoticon sets.

### BACKGROUND OF THE INVENTION

1. Field of the Invention

The present invention relates to text messaging. More specifically, the present invention relates to electronic text messaging featuring a font and set of emoticons selected by an advertiser in return for free or discounted text messaging service.

2. Background of the Invention

There has been a large increase in the advertising market recently. The advertising market for internet and online services has contributed heavily to this increase. There are many websites today that are free for users because the websites are paid for completely by advertisers.

There are many ways to advertise in the current market. Some advertisers put up text or graphic links on websites that are similar to their product while other advertisers like to give users simple ads based on what the user types or where the computer is located. Email has been used to advertise for quite a while now, and some are still using postal mail to advertise.

There are many other services that are completely paid for by advertising other than websites, such as travel brochures, apartment guides, and 411 directory service. Every once in a while one may notice a new car with a large logo on the side of it. Chances are that is the result of an advertiser giving the car away as a promotion provided the driver leave the logo on the car and drive it around every so often. This kind of agreement works because the benefit of owning a car is more than enough to compensate for the unusual logo on the car.

However, the benefit of some free services is not so far and away from the burden the advertising places on the service. There are internet websites that allow the advertisements to take up the whole page, leaving very little content to see at once. There are phone numbers one can call for free directory assistance provided one listens to a short advertisement before one is given directory information, but sometimes the advertisement is not so short. People don't want a free service if its benefit is drowned out by the burden of the advertisements. Generally, the more burdensome the advertising, the less likely someone is to make use of it.

There is a need for a more subtle and non intrusive form of advertising. It follows that the more subtle and less intrusive the advertising is, the more likely someone is to make use of the free service made possible by the advertising no matter how little benefit the service actually is. If the 411 directory phone number limited the length of the advertisements to two seconds, someone would be more likely to call and use the service than if the advertisement lasted two minutes.

The service is the incentive to view or listen to the advertising. The services eligible to be made free must have certain qualities to it. There is no service out there that people wouldn't like to have for free. Every service can attract more attention if it is free. However, the more expensive the service the larger crowd it needs to attract in order for advertisers to be willing to pay for it.

Cellular communication is an area of increasing technology and availability. At the end of 2005, a CTIA study showed that 69% of the United States population subscribed to a cellular telephone service. And everyone is paying for their own cellular telephone services as well. This doesn't just include voice calling, but also, for many, includes text messaging.

Text messaging has become exponentially more popular especially with younger generations. Now that high school kids have cellular telephones, they are able to text message each other in the classroom without the teacher knowing, and that attracts a huge market. The text messaging trend doesn't end after high school though. Many people have found text messaging a convenient way to send a short message to a lot of people. Instead of calling everyone individually to try and make a group effort, one can send one text message and specify multiple recipients. It is also a good way to send pictures, videos, internet hyperlinks, and other forms of multimedia. Many cellular telephones now come equipped with a QWERTY style keyboard for faster text messaging.

Currently, most internet instant messaging and email services are paid for by advertising. Some email services send the user junk mail while others show the user advertisements while the user checks his email through a browser. Most instant messaging programs show the user streaming advertisements within one's list of contacts. This kind of advertising takes up valuable desktop space, and requires extra processing power to constantly load new advertisements while the user is using the service.

Text messaging is a cheap form of communication, and given its mass use, could be a possible target for advertisers to spread their message. Currently, however, cellular communication companies are still charging for this service. Most email and internet instant messaging services are already free, but at the expense of desktop space and efficiency. There needs to be a subtle and non-intrusive method of advertising through text messaging.

### SUMMARY OF THE INVENTION

The present invention is a subsidized text messaging service that subsidizes the price of text messages upon the use of subtle and non-intrusive advertising such as fonts and emoticons in text messages. It can work for cellular text messaging, email, or even internet instant messaging. Text messages use a font, emoticon set, or both that resemble a product, service, trademark, etc. When the recipient reads the text message she'll recall that product, service, or trademark which helps advertisers generate publicity and goodwill. A possible font can be bold-faced and alternate brown and pink colors to resemble DUNKIN DONUTS. A possible emoticon set could be all red circles with dark sunglasses to resemble COOL SPOT, the 7UP cartoon.

In one exemplary embodiment, the present invention is a user-end method of sending text messages for free. Before sending a text message, a user will select which font to use and which emoticon set to use. The user can choose from an entire database of fonts and emoticon sets, each having its own unique characteristics. As long as the user uses a font or emoticon set that corresponds to an advertiser, that text message will be subsidized.

In another exemplary embodiment the present invention is a method of billing users and advertisers for a subsidized text messaging service. Each text message goes through the service provider first. When the service provider receives the text message it checks to see if the message uses a font or emoticon set. If so, the service provider then checks a database for the corresponding advertiser and the amount that advertiser is willing to subsidize for the price of the text message. The service provider bills the advertiser or advertisers the subsidiary amount. Finally the remainder, if any, is billed to the user.

In yet another exemplary embodiment the present invention is a macro-scale system of text message advertising through fonts and emoticon sets. Advertisers seeking publicity create a plurality of fonts and emoticon sets to resemble their product, service, trademark, etc. The service provider compiles the plurality of fonts and emoticon sets into a database. Users can download individual fonts and emoticon sets or the entire database onto their text messaging devices. This scenario provides an environment where users are getting free text messaging, advertisers gaining immediate and widespread publicity, and service providers getting more business out of the application.

### BRIEF DESCRIPTION OF THE DRAWINGS

FIG. 1 shows a method of subsidizing text messages with fonts and emoticons according to an exemplary embodiment of the present invention.

FIG. 2 shows a screen shot of a sample text messaging program according to an exemplary embodiment of the present invention.

FIG. 3 shows a flow diagram of a billing method according to an exemplary embodiment of the present invention.

FIG. 4 shows a macro-scale system of subsidized text messaging according to an exemplary embodiment of the present invention.

FIG. 5 shows a sample group of emoticons with their respective character combinations underneath.

### DETAILED DESCRIPTION OF THE INVENTION

The present invention is a subsidized text messaging service that subsidizes the price of text messages upon the use of subtle and non-intrusive advertising such as fonts and emoticons in text messages. The service provider works with advertisers to collect fonts and emoticon sets that correspond with the advertiser's product, service, trademark, etc.

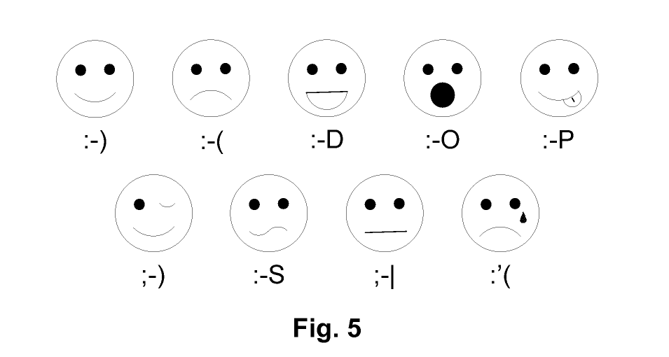

As used in this disclosure, “text message” refers to any electronic communication in the form of text. A “text message” may include other multimedia such as images, audio, or video, as long as it also contains an element of text. “Text messaging service” refers to any service that transfers a “text message” including but not limited to Short Message Service (SMS), Multimedia Message Service (MMS), E-Mail, or Internet instant messaging. Internet instant messaging includes services such as AOL INSTANT MESSENGER (AIM), YAHOO PAGER, and MICROSOFT WINDOWS MESSENGER. “Text messaging device” refers to any device capable of sending a “text message” including but not limited to cellular telephones and computers. “Font” refers to a set of characters that have the same typeface, such as, for example, TIMES NEW ROMAN and COURIER. “Emoticon set” refers to a set of roughly, but not limited to, twelve graphical faces all resembling each other but having different facial expressions as in FIG. 5. Emoticons, sometimes called “smileys”, began as short combinations of ASCII characters that, when viewed sideways, resemble a facial expression. An “emoticon set” may contain as many or as few facial expressions as the advertiser wants. “Advertiser” refers to a company advertising itself or an advertising company doing the advertising for another company. A group of advertisers with a common goal constitutes a single “advertiser” for purposes of this disclosure. “Subsidize” refers to an advertiser paying for part or the entire price of a text message.

A font suitable for advertising use in a text message must have some form that, when viewed, makes the viewer recall a certain product, service, trademark, etc. A font generally consists of every alpha-numeric character, including upper and lower case, punctuation marks, etc. Many companies and businesses already use advertisements with a certain lettering style to them. For instance DUNKIN DONUTS has used a bold font with pink and brown colors. If DUNKIN DONUTS wanted to make an advertising font, it would probably start with a bold font of alternating brown and pink letters. COCA-COLA normally uses a cursive font for their logo. A COCA-COLA advertising font might be a two-toned cursive lettering that perhaps makes each “C” look exactly as it does on its logo. These are mere examples an a given advertiser may choose a variety of different styles in order to advertise in the form provided for in the present disclosure.

An emoticon set suitable for advertising use in a text message must have some form to it that, when viewed, makes the viewer recall a certain product, service, trademark, etc. An emoticon set normally features around twelve different expressions. One can be a simple smiling face, another a sad face, while yet another has an angry face. A sample of a very basic emoticon set is shown in FIG. 5. The characters underneath each emoticon are the characters that emoticons seek to replace. Notice how when tilted to the side, each character set resembles the respective emoticon. That is because emoticons began as character combinations, but many programs now automatically replace those character combinations with colorful, right-side-up, clear images. Emoticons are different than fonts in that emoticons are not used as often, or maybe not at all. If an advertiser wants a consumer to recall their product, service, trademark, etc., while viewing the text message, the emoticon may need to be more distinct. For example, if AT&T wanted to make an advertising emoticon set, it could start by using the white and blue-striped globe with simple faces drawn on top. Many emoticons are circular in shape (to resemble a head), but this is not necessary. If a network wanted to advertise its new television show or movie, it could start by using a head of each of the cast members, each having a different expression on their face.

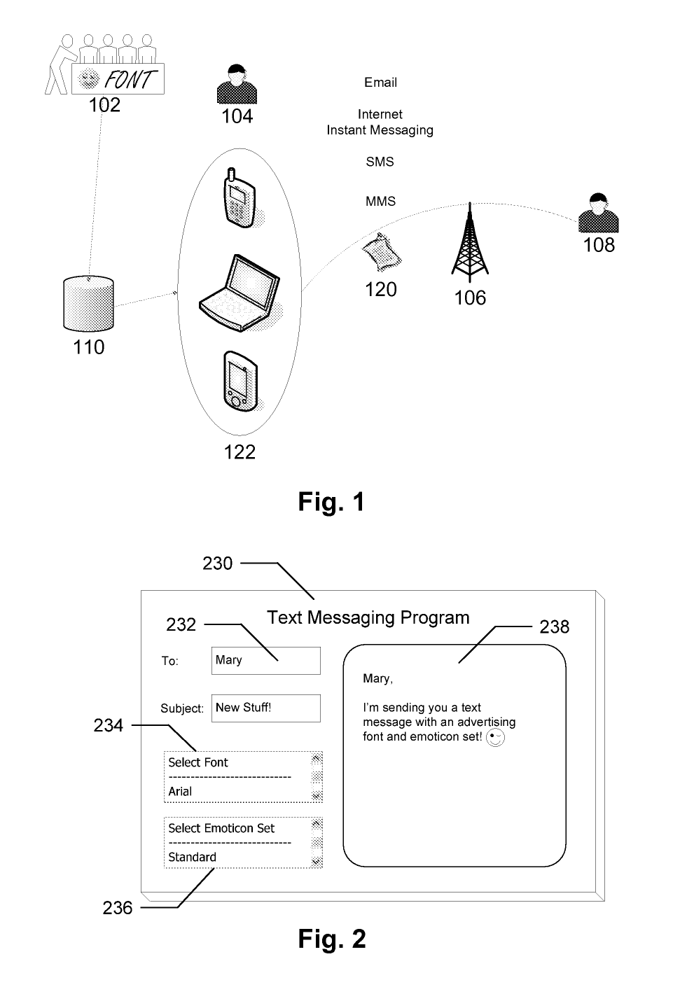

In an exemplary embodiment shown in FIG. 1, the present invention is a user end system of sending subsidized text messages. Advertisers 102 create fonts and emoticon sets which are compiled into a database 110. At the request of a user 104, one or more fonts and emoticon sets are then loaded onto the user's text messaging device 122. The service provider 106 may provide the user with a text messaging device 122 if the user does not already have one. The text messaging device 122 may be a cellular telephone, computer, PDA, etc.

When a user 104 decides to send a text message 120 he or she may load the appropriate program to send text message 120. For example, this could be accomplished using SMS, MMS, email, or internet instant messaging program, such as the program shown in FIG. 2. Once the program has loaded, user 104 may select a font to use with the text message 120. User 104 may have a choice of selecting a font that corresponds with an advertiser or one that does not. The user 104 may also select an emoticon set to use with the text message 120 if the user plans on inserting emoticons in the message to show emotion. If the user 104 does choose an advertiser's 102 font, that advertiser 102 will subsidize the price of the text message 120. If the user 104 chooses and uses an advertiser's 102 emoticon set as well, that advertiser 102 will subsidize the price of the text message 120 whether or not it is the same advertiser as corresponds to the font. An end user 108 receives the message prepared and sent by user 104 which includes fonts and/or emoticons that are particular to a given advertiser 102.

Alternatively, the system can push a font onto the user 104 that will be automatically subsidized by an advertiser if the system knows that the user 104 has a particular affinity to a certain product. For example, through past search or activity, if the system recognizes that the user 104 is a frequent purchaser of doughnuts, then the system will push a subsidized font that is provided by DUNKIN DONUTS.

In yet another alternative embodiment, the font could be automatically chosen based on the content of the message. The font could change in response or recognition of a key word. For example, if the word “doughnuts” or “donuts” is used in a message, then the DUNKIN DONUTS font is automatically pushed on to the user. Another example would be the use of STARBUCKS fonts whenever the key word “coffee” is used in a text. The examples are endless.

FIG. 2 shows a sample text messaging program 230 user 104 can use to send a SMS or MMS message, email, or internet instant message. User 104 must first choose one or more recipients 232, and can elect to fill in a subject 234 as well. Then user 104 can select a font 234 and an emoticon set 236 to use with the text message. Since there are many fonts and emoticon sets available, not all of them will be associated with an advertiser. Then user 104 can write the text message in dialogue box 238 and it will be sent using the font 234 and emoticon set 236 selected on the left side.

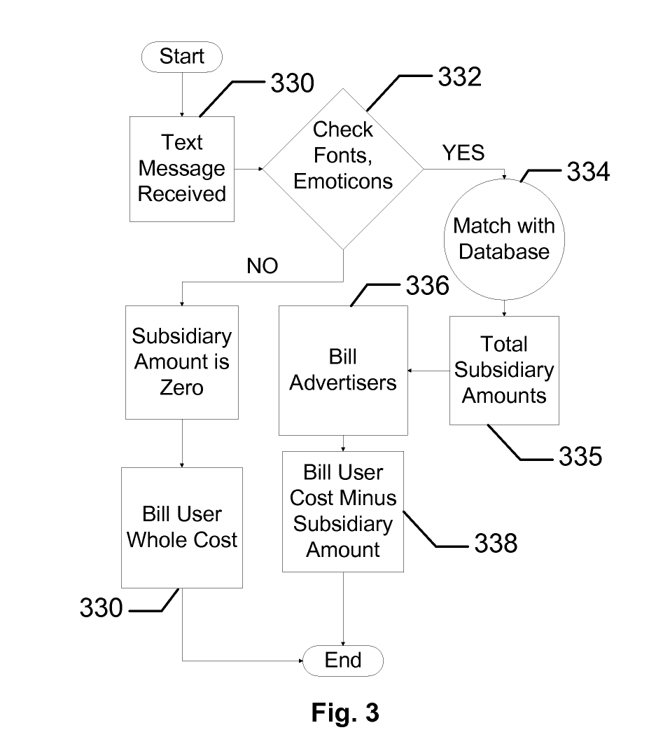

In another exemplary embodiment, shown in FIGS. 1 and 3, the present invention is a method of billing according to a subsidized text messaging service. The service provider 106 has a database 110 of all the fonts and emoticon sets given to them by advertisers 102. Also in database 110 is the amount of the price of the text message the advertiser 102 is willing to subsidize for use of its font or emoticon set. This amount may vary with each advertiser 102 and may be different for their font and emoticon sets. Advertisers 102 may have many different fonts and emoticon sets in database 110, each having a different subsidiary amount associated with them. This amount may be apparent to the user 104 before sending text message. Should a user 104 wish to send a text message with more than one font or emoticon set, advertisers 102 can split the price of the text message. This can be done in many ways, for example, by each advertiser 102 paying half of their normal subsidiary amount, or by contributing an amount based on the portion of the message that actually uses the advertiser's font or emoticon set.

As shown in FIG. 3, and in combination with FIG. 1, when a user sends a text message, the service provider receives the text message first in step 330. Next the service provider determines if the text message is using a font or emoticon set that corresponds with an advertiser, shown as step 332 in FIG. 3. If the text message does contain corresponding fonts or emoticons, the service provider matches the fonts and emoticons with advertisers in database 110 to determine subsidiary amounts in step 334. Once the subsidiary amounts are found, they are totaled in step 335. The service provider then bills the advertisers for their respective subsidiary amounts, shown as step 336. Once all the subsidiary amounts are accounted, the price of the text message is reduced by the total subsidiary amount. The remainder, if any, is then billed to the user in step 338. If the text message does not contain any corresponding fonts or emoticons then it is not subsidized and the user is billed for the whole price of the text message, shown as step 339.

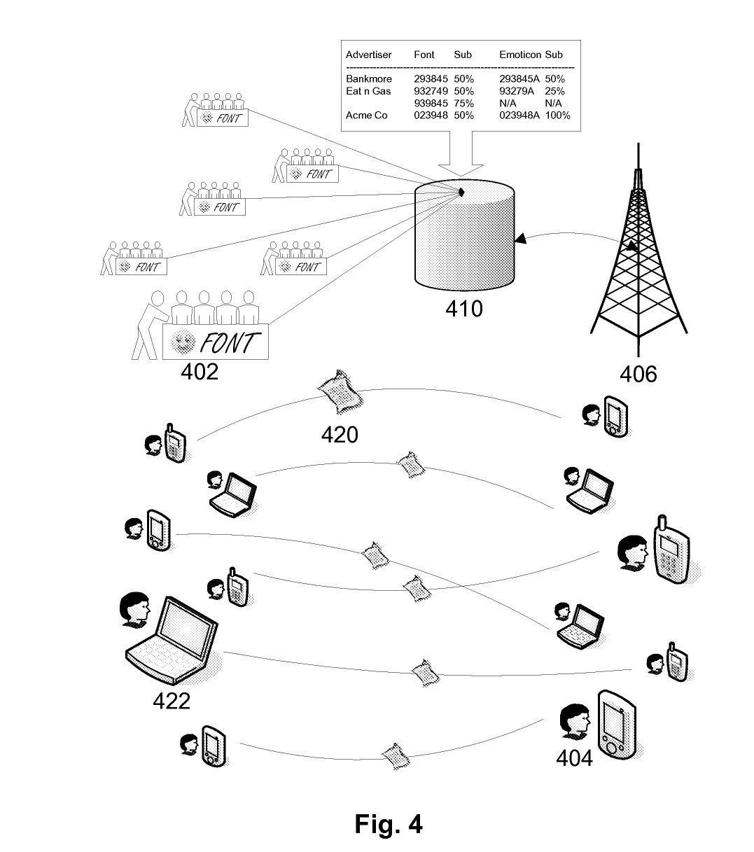

In yet another exemplary embodiment shown in FIG. 4, the present invention is a macro-scale system of subsidizing the price of text messages with the use of fonts and emoticon sets that correspond to advertisers 402. The advertisers 402 create the fonts and emoticon sets so that when used in a text message the reader recalls that advertiser's product, service, trademark, etc. The service provider 406 then collects the fonts and emoticon sets from the advertisers and compiles them into database 410. Database 410 contains information about each advertiser 402 that has given service provider 406 a font or emoticon set. Each advertiser 402 is linked to their fonts and emoticon sets and every font and emoticon set has a corresponding subsidiary amount. The subsidiary amount is a set amount or percentage of the price of a text message 420 that an advertiser is willing to pay to a user who has used their font or emoticon set in a text message. Service provider 406 distributes the fonts and emoticon sets to its users 404 who wish to send subsidized text messages. Users 404 send each other text messages as much as they want, whenever they want, and most of the text messages could probably be free to users 404. Service provider 406 receives more business due to the incentive of free text messaging. Advertisers 402, though paying for the text messages, get more public exposure which increases their own businesses.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method of advertising comprising the steps of:
registering a user for a text messaging service;
supplying the user with font and/or emoticon set that includes at least one subsidized font and/or emoticon set to use with the text messaging service;
wherein the text messaging service is subsidized upon the user using one of the subsidized fonts and/or emoticon sets.

2. The method in claim 1, wherein the supplying step further comprises supplying the user with a text messaging device.

3. The method in claim 1, wherein the supplying step further comprises loading the user's text messaging device with fonts and emoticon sets.

4. The method in claim 1, wherein the text messaging service can be SMS, MMS, Email, or Internet instant messaging.

5. The method in claim 1, wherein the font and/or emoticon set resemble an advertiser's product, service, or trademark.

6. The method in claim 1, wherein the text message is subsidized by advertisers.

7. The method in claim 6, wherein the advertisers choose an amount to subsidize text messages which can be a portion or the entire price of the text message.

8. A method of billing subsidized text messages comprising the steps of:
receiving a text message using a font and/or emoticon set from a user;
billing a corresponding advertiser a subsidiary fee for the text message; and
billing the user a remainder of the fee for the text message;
wherein the advertiser corresponds to the font and/or emoticon set used in the text message.

9. The method in claim 8, wherein the subsidiary fee billed to the advertiser may be a portion or a whole of a price of the text message.

10. The method in claim 8, wherein a database includes all of the fonts and/or emoticon sets, the corresponding advertisers, and a subsidiary amount for each font and/or emoticon set.

11. The method in claim 10, further comprising matching the font and/or emoticon set in the text message with the corresponding advertiser and subsidiary amount in the database before billing.

12. The method in claim 8, wherein the subsidiary amount may be split among multiple advertisers when a text message uses more than one font and/or more than emoticon set.

13. A system of advertising incentives comprising:
a plurality of fonts and/or a plurality of emoticon sets, wherein each individual font and/or emoticon set is linked to a corresponding advertiser;
a plurality of text messaging devices, each having one or more fonts and/or emoticon sets; and
a plurality of users using the plurality of text messaging devices to send a plurality of text messages;
wherein each text message sent using a font and/or emoticon set is subsidized by the corresponding advertiser.

14. The system in claim 13, wherein the user may select the font and/or emoticon set for each text message.

15. The system of claim 13, wherein each font and/or emoticon set has its own subsidized cost structure.

16. The system in claim 13, wherein advertisers design each font and/or emoticon set to resemble a product, service, or trademark.

17. The system of claim 16, wherein an advertiser designs a font and/or emoticon set to resemble multiple products, services or trademarks.

18. The system of claim 16, wherein more than one advertiser are combined for a given font and/or emoticon set.

19. The system in claim 13, wherein the text messaging device can be a cellular telephone, PDA, or computer.

20. The system in claim 13, wherein the plurality of text messages includes SMS, MMS, Email, and Internet instant messaging.
